(19) United States
(12) Patent Application Publication
(10) Pub. No.: US 2015/0063144 A1
(43) Pub. Date: Mar. 5, 2015

(54) METHOD AND APPARATUS FOR SOFTWARE DEFINED FLOW CONTROL IN WIRELESS SYSTEMS

(71) Applicant: Ulas C. Kozat, Santa Clara, CA (US)

(72) Inventor: Ulas C. Kozat, Santa Clara, CA (US)

(21) Appl. No.: 14/470,611

(22) Filed: Aug. 27, 2014

Related U.S. Application Data
(60) Provisional application No. 61/873,762, filed on Sep. 4, 2013.

(51) Int. Cl. H04W 28/10; H04W 24/02

(52) U.S. Cl. CPC H04W 28/10; H04W 24/02
USPC 370/252

(57) ABSTRACT

A method and apparatus is disclosed herein for performing flow control. In one embodiment, the method is for use in a wireless network apparatus that includes a controller, wireless entities, user equipments, and includes the following operations: collecting, by the controller, signal strength measurements from entities of the plurality of wireless entities; collecting, by the controller, channel quality indicators (CQI) information provided by one or more UEs of the at least one UEs; generating a CQI estimate for each entity of the plurality of entities not serving a flow to a UE; and determining, by the controller, forwarding decisions for one or more flows to specify which wireless entity is to serve which flow, based on one or more of the signal strength measurements, the channel quality indicators (CQIs) provided by one or more UEs, and one or more generated CQI estimates associated with entities not serving a flow to a UE.

### PRIORITY

The present patent application claims priority to and incorporates by reference the corresponding provisional patent application Ser. No. 61/873,762, titled, “A Method and Apparatus for Software Defined Flow Control in Wireless Systems,” filed on Sep. 4, 2013.

### FIELD OF THE INVENTION

Embodiments of the present invention relate to the field of wireless communication; more particularly, embodiments of the present invention relate to software defined flow control in a wireless communication system using a controller.

### BACKGROUND OF THE INVENTION

In prior art wireless communication systems, radio resource management mainly focuses on making handover decisions based on received signal strength, cell load, and interference management points of view. These prior art systems also make per flow QoE decisions mainly based on the perceived network quality without having a more global perspective of how capacity is provisioned or to be provisioned in the network. In prior art, the programmability of wireless networks is either very much software radio oriented where the radio protocol stack is itself programmable without addressing the needs for future heterogeneous wireless networks.

In prior network communication systems, flow control is a function that manages the flow of data (e.g., packets) between elements, such as nodes in a network. Flow control can be software based or hardware based.

Software-Defined Networking (SDN) is an architecture that uses an application referred to as an SDN controller to manage flow control between network elements. In the architecture, the network control plane is separated from the forwarding plane, thereby enabling the network control plane to be programmable and the network infrastructure to be abstracted from the network servers that make use of the network infrastructure.

Concepts associated with software defined flow control have been proposed with wireless infrastructures. For example, OpenRF is a wireless protocol that opens up PHY and MAC layer transmission nodes to a network controller over which flow based PHY and MAC layer options can be selected. Additionally, SoftRAN (Software Defined Radio Access Network) proposes a framework for centralized management of multiple cell sites to perform handovers, allocate resource blocks to each flow, and assign transmit powers.

### SUMMARY OF THE INVENTION

A method and apparatus is disclosed herein for performing flow control. In one embodiment, the method is for use in a wireless network apparatus that includes a controller, wireless entities, user equipments, and includes the following operations: collecting, by the controller, signal strength measurements from entities of the plurality of wireless entities; collecting, by the controller, channel quality indicators (CQI) information provided by one or more UEs of the at least one UEs; generating a CQI estimate for each entity of the plurality of entities not serving a flow to a UE; and determining, by the controller, forwarding decisions for one or more flows to specify which wireless entity is to serve which flow, based on one or more of the signal strength measurements, the channel quality indicators (CQIs) provided by one or more UEs, and one or more generated CQI estimates associated with entities not serving a flow to a UE.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates one embodiment of a programmable HetNet Architecture.

FIGS. 2A and 2B illustrate signal strength reporting from base stations to a controller.

FIG. 3 illustrates per-flow queue state feedback from base stations to a controller.

FIG. 4 illustrates a data flow diagram of a process for updating a per-flow table and flow priorities.

FIG. 5 is a data flow diagram of one embodiment of a process for performing flow and priority level control.

FIG. 6 depicts a block diagram of a controller in a wireless communication system.

FIG. 7 illustrates a set of code (e.g., programs) and data that is stored in memory of one embodiment of a controller in a wireless communication system.

### DETAILED DESCRIPTION OF THE PRESENT INVENTION

A wireless network apparatus having a number of wireless elements and a network entity that controls other wireless entities is described. In one embodiment, the other wireless entities being controlled include at least one base station and potentially one or more switches and/or routers is described. A wireless entity includes controller that controls the base stations, switches and routers by controlling which of the data flows (e.g., packet flows) that each of these entities is serving and the priority at which they are served. To enable this control, in one embodiment, the base stations, switches and routers expose the programmability of the priority level (e.g., QoS classes) of each flow and expose the programmability of routing tables (e.g., the routing table entries) that dictate which flow is to be served by which base station.

In one embodiment, the network entity (e.g., controller) collects one or more of the following: signal strength measurements in the uplink from each base station it controls, channel quality indication information (e.g., channel quality indicators (CGIs)) as they are reported by a user equipment (UE) (e.g., a mobile unit) to the base station currently serving one or more flows to it, per-flow queue states, information indicative of the amount of retransmission that has occurred between a UE and its serving base station, and information indicating packet loss events. In one embodiment, the network entity estimates missing channel quality indicators for the base stations under its control.

In one embodiment, the network entity uses all or a subset of flow profiles, per flow queue states, CQI estimates, packet loss and retransmission events to determine the best base station to serve a given flow and the best priority level for that given flow. The network entity notifies the base station of such decisions. In one embodiment, the network entity programs the base stations, switches and routers to reflect the most recent base station and flow priority decisions in the respective flow and priority tables of these network elements.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

### Overview

Embodiments of the invention include a radio network apparatus that aggregates flow routing and flow quality (e.g., QoS class) decisions across multiple radio access network elements and core network elements at a logically centralized controller that dictates which packets of what flows should be transmitted from which base station element (or equivalently in which cell) and at what priority. In one embodiment, base stations and routers (e.g., core network routers such as edge and gateway routers) report their queue states and flow statistics to the controller. In one embodiment, base stations report their signal measurements in the uplink as well as CQI reports collected from user equipments (UEs) to the same controller.

Based on the information received from the base stations and routers, the controller constructs a radio signal map in terms of signal strengths reported for each user equipment from different base stations. In accordance with the per-flow quality requirements or service profiles, and using this signal map, the controller modifies per-flow routing table entries as well as flow priority levels (or QoS classes) at topologically relevant routers and base stations.

Embodiments of the invention are particularly relevant to small cell architectures, where a macro-cell provides a continuous coverage to UEs within its coverage area and a number of small cells within the same coverage area serve as forwarding plane entities. The macro-cell makes the radio resource management decisions such as which resource block is used by which UE and/or which small cells at a given scheduling interval. Small cells and macro cells also autonomously decide on the transmission mode such as precoding, modulation, error correction coding, etc. for each user they are serving and carry out the transmission. In making this decision, small cell and macro cell base stations use the QoS class/priority information dictated by the logically centralized controller on a per flow basis.

Advantageously, embodiments of the invention logically centralize the forwarding and quality of service (QoS) or quality of experience (QoE) decisions for each network flow to the same or distinct wireless subscribers while maintaining the distributed and scalable structure of the forwarding plane. Also, embodiments of the invention do not require a change in radio stack and transmission standards, yet it allows a more globally optimized resource allocation decisions based on the network state and flow QoS/QoE requirements.

Furthermore, embodiments of the invention provide a better utilization of coverage and capacity based on the network load and flow requirements using a novel architecture and disclosing methods on how to program the forwarding plane.

Embodiments of the invention allow network operators a better way of utilizing capacity and coverage of the network over heterogeneous networks with many small cells are overlaid by macro cells.

### An Example of a Wireless Communication System

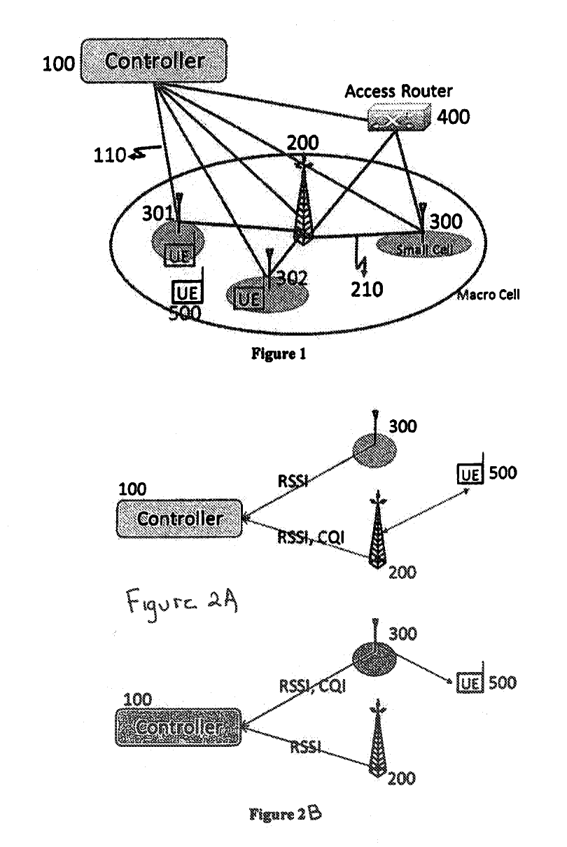

The techniques described herein may be used in many different wireless communication systems. FIG. 1 illustrates one embodiment of a heterogeneous wireless network communication system in which the techniques described herein may be used. Referring to FIG. 1, a number of small cell sites are overlaid by a macro cell such that the service area of small cells are mainly used for faster transmission speeds and macro cells provide continuous undisrupted coverage. Specifically, the wireless communication system includes base station 200 and small cells 300-302. In one embodiment, small cells 300-302 are reduced-function base stations as described in more detail below.

The wireless communication system includes one or more user equipments (UEs), such as UE 500 (e.g., a mobile unit). Note that they could be many more UEs in the system. In one embodiment, the UEs (e.g., UE 500) are unaware of the existence of the small cells and they handover from one macro cell to another. In one embodiment, there is no mobile assisted or initiated handover between small cells or small cell and macro cell as long as the small cells and the macro cell are under the control of the same controllers. Small cells in such scenarios simply carry out the standard radio link layer, MAC and physical layer transmission and reception for the user packets they are programmed to transmit and receive. In one embodiment, the macro cell base station makes radio resource allocations to small cells and directly forwards the downlink packets to small cells. In another embodiment, a controller, such as controller 100, also assigns radio resource block allocations to each cell. Yet, in another embodiment, the small cell receives flows directly from a router, such as access router 400, programmable by the same controller, such as controller 100.

In one embodiment, controller 100 communications with base station 200, small cells 300-302 and access router (and any other routers and switches) using a data link. In one embodiment, the data link among base stations well as between base stations and routers under the control of this logically centralized controller 100 can be a direct cable, a wireless link, an L2 or L3 tunnel, or a combination of multiple transport fabrics over multiple hops.

In one embodiment, controller 100 collects signal strength measurements in the uplink from each base station it controls, channel quality indication information (e.g., channel quality indicators (CGIs)) as they are reported by UEs to the base station currently serving one or more flows to it, per-flow queue states, information indicative of the amount of retransmission that has occurred between a UE and its serving base station, and information indicating packet loss events. In one embodiment, controller 100 also estimates missing channel quality indicators for the base stations under its control. Controller 100 uses all or a subset of flow profiles, per flow queue states, CQI estimates, packet loss and retransmission events to determine the base station to serve a given flow and the priority level for that given flow. The network entity notifies the base station of such decisions. In one embodiment, the network entity programs the base stations, switches and routers to reflect the most recent base station and flow priority decisions in the respective flow and priority tables of these network elements.

In one embodiment, controller 100 installs routing/forwarding rules on a per flow basis to access routers and base stations to implement the routing and priority decisions. The installation may be implemented by modifying routing tables at an access router or macro cell base station. These modifications may be sent via the direct link that exists between controller 100 and the routers and base stations.

In one embodiment, each small cell (e.g., small cells 300-302) and macro cell base stations (e.g., base station 200) report their received signal strength (e.g., RSSI, RSRP, etc.) to controller 100 as they measure them in the uplink direction (i.e., for the signals received from user equipment). When a UE receives data transmissions from macro cell base station where macro cell base station (e.g., base station 200) is sending and receiving to and from the UE (e.g., UE 500), the UE measures the downlink signal quality and reports the channel quality indicator (CQI) back to the base station. The base station makes use of CQI to perform the rate adaptation. This CQI feedback from the UE is forwarded by the base station to the controller (e.g., controller 100). This is shown in FIG. 2A.

In a similar fashion, when the sending base station is a small cell base station, where small cell base station (e.g., small cell 300) is serving the UE (e.g., UE 500), the CQI feedback by the UE will be the quality of the channel between the small cell base station and the user equipment. This is shown in FIG. 2B. As small cells and the macro cell are indistinguishable by UEs, it is only the base stations and the controller that know what each CQI feedback is for which transmitter-receiver pair.

Although the feedback information described above can be directly used by the sending base station for rate adaptation, in one embodiment, in order to determine the CQI between all candidate base stations to UEs, estimation is required. More specifically, Each user sends back CQI feedback, but these CQI values correspond to the current base station serving them. Thus, the CQI value from other base stations for that particular user is missing and must be estimated. In one embodiment, the controller estimates missing CQIs. In one embodiment, a missing CQI corresponds to one generated for each base station not serving a specific flow that is being served by another base station (including small cell).

In an embodiment, when user equipment X reports CQI after it receives a packet from base station J, this CQI is labeled as CQI_{J,X} to indicate that it is the channel quality for the transmissions from J to X. In one embodiment, CQI is a quantized value, where a range of SINR values are mapped to an integer. Let F be a single-valued function used to map SINR (carrier signal power to interference and noise power ratio) measurements into CQI levels {0, 1, . . . , K}. Such mappings are commonly used for rate adaptation purposes to select the correct coding and modulation scheme. Let G be another function that maps the CQI level back to an SINR value. For instance, if F maps the interval [SINRₖ,SINRₖ₊₁) to CQI level k, then an example G function would map CQI level k to SINRₖ, i.e., the minimum SINR value that qualifies as CQI level k. Other function forms can be used to select an interpolated value between SINRₖ and SINRₖ₊₁. Suppose base station J has a measurement of uplink received signal strength for transmissions by X and labels the most recent measurement as RSSI_{X,J}. Similarly, another base station M has a similar measurement of an uplink received signal strength denotes as RSSI_{X,M}. Let all the SINR and RSSI measurements be specified in dBm. Then, in one embodiment, the controller estimates the CQI_{M,X} as follows:

CQI_{M,X}=F(G(CQI_{J,X})+RSSI_{X,M}−RSSI_{X,J}+P_{M}−P_{J}) (1)

where P_{M} is the transmission power at base station M and P_{J} is the transmission power at base station J.

More specifically, F(x) maps intervals of RSSI values to integer values. Let RSSI₁<RSSI₂< . . . <RSSI_{K} be the threshold values in dBm. Let there will be K different transmission modes supported in the radio access technology, where f(x)=0 corresponds to no connection state, and f(x)=K corresponds to the highest transmission rate. If x<RSSI₁, then f(x)=0; else if RSSI₁≦x<RSSI₂, then f(x)=1; . . . ; else if RSSI_{K-1}≦x<RSSI_{K}, then f(x)=K−1; else x≧RSSI_{K}, then f(x)=K. G(x) is the pseudo-inverse function of F(x) and, in one embodiment, it is not unique for a given F(x). The variable x is an integer valued from 0 to K. In one embodiment, G(x)=RSSIₓ with RSSI₀=0 and RSSIₓ for x=1, . . . , K is defined as the same thresholds used by F(x). In another embodiment, G(x)=(RSSIₓ+RSSIₓ₊₁)/2.

In the TDD (time division duplexing) system, no CQI is sent by the UE. A UE sends the pilot and base stations make channel estimations. Thus, base stations can also send their own estimates in another embodiment to the controller.

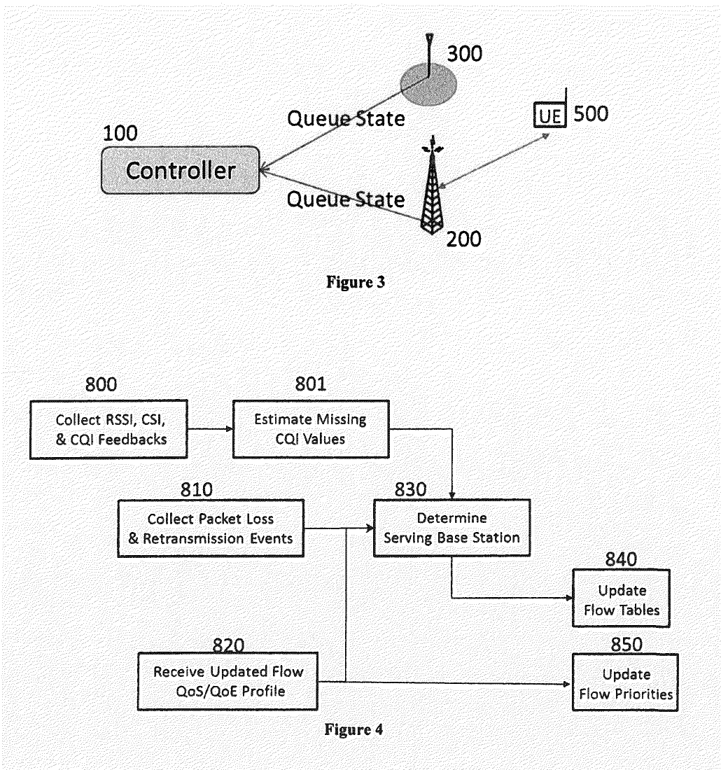

In another embodiment, the controller collects the Queue State information from the base stations to monitor the queue backlog (i.e., how many bytes of packets are waiting to be served) and service rate information on a per flow basis (see FIG. 3).

In another embodiment, the controller receives QoE/QoS targets and profiles for each flow from a service management layer. For instance, a video streaming service can specify the minimum service rate to stream a video without pauses. A VoIP service can specify minimum losses. A live video broadcast or conferencing can specify higher packet loss rates. Background traffic flows (e.g., software updates, data being synched up from/to cloud) can be completely elastic and delay tolerant. Depending on these requirements, in one embodiment, the controller routes a particular flow always from a macro cell base station, always from a small cell base station, or can opportunistically make use of small cells while being served from macro cell base station.

### Examples of Collection and Update Processes

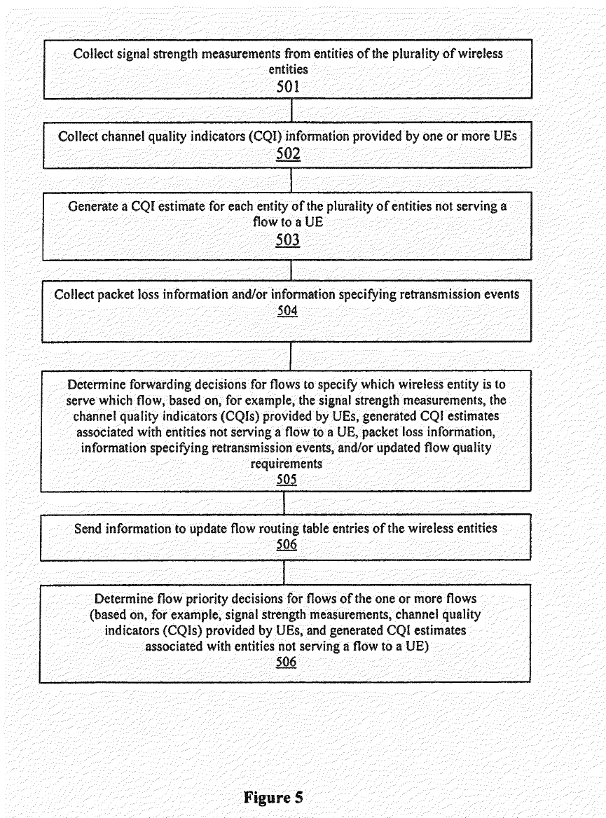

FIG. 4 is one embodiment of a flow diagram of a process for collecting measurements and updating flow and priority tables. The process is performed by processing logic that may comprise hardware (circuitry, dedicated logic, etc.), software (such as is run on a general purpose computer system or a dedicated machine), firmware, or a combination of all three. In one embodiment, the process is performed by a controller (e.g., controller 100 of FIG. 1) and is used in a wireless network apparatus comprising a plurality of wireless entities (e.g., base stations, routers (e.g., edge router, gateway routers, etc.), switches, etc.) that controlled by the controller and one or more user equipments (UEs).

Referring to FIG. 4, the processing includes processing logic collecting received signal strength measurements, channel state information, and channel quality indicators (processing block 800). Then, processing logic computes the missing CQI estimates from the base stations towards each UE (processing block 801). One such estimation example is provided in equation (1) above. As parallel processes, processing logic collects packet loss events and retransmission events (processing block 810). In one embodiment, if the loss events or retransmissions are too high for a particular flow using a small cell, then the remaining packets of the flow can be switched towards the macro-cell base station.

Processing logic receives updated flow QoS/QoE profile based on Queue State feedback as well as potentially a direct request from the service/application that generates the flow (processing block 820).

Processing logic uses combinations of estimations and updates of processing blocks 801, 810, and 820 to make a decision process to pick the serving base station (processing block 830). In one embodiment, the processing logic constructs a radio signal map in terms of signal strengths reported for each UE from different base stations. In one embodiment, this radio signal map represents RSSI fingerprints and its use for user positioning is well-known. Using this signal map, the processing logic modifies per-flow routing table entries and flow priority levels (or QoS classes) at routers and base stations in accordance with the per-flow quality requirements or service profiles.

Note that in one embodiment, the operations performed by processing logic in processing block 820 alone also can alter the flow priorities. In one embodiment, the flow priorities are modified at an access router or macro base station or small cell base station by rewriting a priority field in the packet header that is processed by a QoS scheduler or by explicitly communicating with the QoS scheduler with an explicit session/connection ID exposed for such programmability (e.g., explicit control signaling with the QoS scheduler to change the flow priority level).

Once the serving base station for a flow has been decided, processing logic updates the flow tables (processing block 840) and updates flow priorities (processing block 850). In one embodiment, updating the flow tables comprises modifying routing tables at an access router or macro cell base station using a standard interface (e.g., OpenFlow). One example is given in Table 1 where the macro-cell and access router flow tables are populated with flow entries pointing each flow to a particular base station.

TABLE 1
Flow Table at a Macro Cell Base Station or Router

| FLOW ID | Port (Cell) ID |
|---|---|
| F₁ | 200 |
| F₂ | 302 |
| F₃ | 301 |
| . | . |
| . | . |
| . | . |
| F_{N} | 300 |

In one embodiment, updating the flow priorities comprises specifying what QoS or QoE class to use for a flow. In one embodiment, to update the flow priorities, the controller (e.g., controller 100) sends “priority update” messages to the schedulers in each base station to alter the QoS class for the flow or directly sets a flow weight for more direct control. The controller knows the priority states or flow weights with which each scheduler was last programmed, so it can update the weights appropriate amounts. Updating priorities may include modifying weights or mapping of flows to particular priority QoS or QoE classes. Once set, the ingress port of the flow merely labels it and the routers act accordingly in a manner well-known in the art.

In one embodiment, packets being buffered at a particular base station that no longer serves a UE are dropped. In another embodiment, packets being buffered at a particular base station that no longer serves a UE are rerouted to the correct base station by dynamically programming the routing table entries.

FIG. 5 is a data flow diagram of a process for performing flow control. The process is performed by processing logic that may comprise hardware (circuitry, dedicated logic, etc.), software (such as is run on a general purpose computer system or a dedicated machine), firmware, or a combination of all three. In one embodiment, the process is performed by a controller (e.g., controller 100 of FIG. 1) and is used in a wireless network apparatus comprising a plurality of wireless entities (e.g., base stations, routers (e.g., edge router, gateway routers, etc.), switches, etc.) that controlled by the controller and one or more user equipments (UEs).

Referring to FIG. 5, the process begins by processing logic collecting signal strength measurements from entities of the plurality of wireless entities (processing block 501) and collecting channel quality indicators (CQI) information provided by one or more UEs of the at least one UEs (processing block 502).

Processing logic also generates a CQI estimate for each entity of the plurality of entities not serving a flow to a UE (processing block 503).

In one embodiment, processing logic also collects packet loss information and/or information specifying retransmission events (processing block 504).

Based on the collected and/or generated information, processing logic determines forwarding decisions for flows to specify which wireless entity is to serve which flow, based on one or more of the signal strength measurements, the channel quality indicators (CQIs) provided by one or more UEs, and one or more generated CQI estimates associated with entities not serving a flow to a UE (processing block 505). In one embodiment, processing logic also determines forwarding decisions for the one or more flows is based on the one or both of packet loss information and information specifying retransmission events. In another embodiment, processing logic also determines forwarding decisions for one or more flows to specify which wireless entity is to serve which flow is based on updated flow quality requirements. In one embodiment, the channel quality indicators (CQI) information provided by the UEs is provided to the controller via the wireless entity (e.g., the base station) currently serving a flow to the UE.

In one embodiment, determining forwarding decisions for one or more flows to specify which wireless entity is to serve which flow comprises selecting a wireless entity with a best CQI in comparison to the other wireless entities in the plurality of entities to serve a particular flow. For example, in one embodiment, the processing logic (e.g., controller) selects the wireless entity with the best CQI to serve a particular flow. In another embodiment, determining forwarding decisions for one or more flows to specify which wireless entity is to serve which flow comprises switching from a first wireless entity serving a particular flow to a second wireless entity to serve the particular flow if CQI information of the first wireless entity drops to below a value. In one embodiment, the value is a threshold value. In one embodiment, the value is CQI information of the second wireless entity. In yet another embodiment, determining forwarding decisions for one or more flows to specify which wireless entity is to serve which flow comprises switching from a first wireless entity serving a particular flow to a second wireless entity to serve the particular flow if QoS information of the second wireless entity changes from a low value to a high value.

In response to flow determinations, processing logic sends information to update flow routing table entries of one or more wireless entities of the plurality of wireless entities (processing block 506).

Based on the collected and/or generated information, processing logic determines flow priority decisions for flows of the one or more flows (processing block 507). In one embodiment, these determinations are based on one or more of the signal strength measurements, the channel quality indicators (CQIs) provided by one or more UEs, and one or more generated CQI estimates associated with entities not serving a flow to a UE. In another embodiment, these decisions as also based upon updated flow quality requirements.

### One Embodiment of a Controller

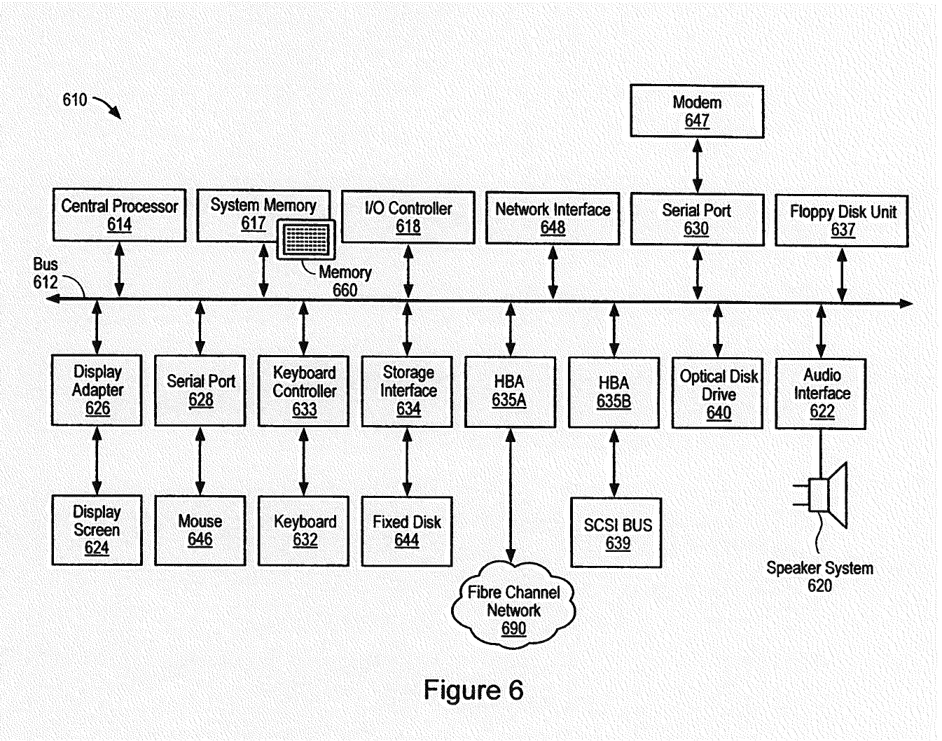

FIG. 6 depicts a block diagram of a controller for a wireless communication system, such as controller 100 of FIG. 1. Referring to FIG. 6, controller 610 includes a bus 612 to interconnect subsystems of security gateway 610, such as a processor 614, a system memory 617 (e.g., RAM, ROM, etc.), an input/output controller 618, an external device, such as a display screen 624 via display adapter 626, serial ports 628 and 630, a keyboard 632 (interfaced with a keyboard controller 633), a storage interface 634, a floppy disk drive 637 operative to receive a floppy disk 638, a host bus adapter (HBA) interface card 635A operative to connect with a Fibre Channel network 690, a host bus adapter (HBA) interface card 635B operative to connect to a SCSI bus 639, and an optical disk drive 640. Also included are a mouse 646 (or other point-and-click device, coupled to bus 612 via serial port 628), a modem 647 (coupled to bus 612 via serial port 630), and a network interface 648 (coupled directly to bus 612).

Bus 612 allows data communication between central processor 614 and system memory 617. System memory 617 (e.g., RAM) may be generally the main memory into which the operating system and application programs are loaded. The ROM or flash memory can contain, among other code, the Basic Input-Output system (BIOS) which controls basic hardware operation such as the interaction with peripheral components. Applications resident with computer system 610 are generally stored on and accessed via a computer readable medium, such as a hard disk drive (e.g., fixed disk 644), an optical drive (e.g., optical drive 640), a floppy disk unit 637, or other storage medium.

Storage interface 634, as with the other storage interfaces of computer system 610, can connect to a standard computer readable medium for storage and/or retrieval of information, such as a fixed disk drive 644. Fixed disk drive 644 may be a part of computer system 610 or may be separate and accessed through other interface systems.

Network interface 648 may provide a direct connection to wireless entities such as, for example, base stations 200, 300-302 and access router 400 of FIG. 1. Network interface 648 may provide a direct connection to a remote server via a direct network link to the Internet via a POP (point of presence). Network interface 648 may provide such a connection using wireless techniques, including digital cellular telephone connection, a packet connection, digital satellite data connection or the like. Modem 647 may provide a direct connection to a remote server via a telephone link or to the Internet via an internet service provider (ISP).

Many other devices or subsystems (not shown) may be connected in a similar manner (e.g., document scanners, digital cameras and so on). Conversely, all of the devices shown in FIG. 6 need not be present to practice the techniques described herein. The devices and subsystems can be interconnected in different ways from that shown in FIG. 6. The operation of a computer system such as that shown in FIG. 6 is readily known in the art and is not discussed in detail in this application.

Code to implement the controller operations described herein can be stored in computer-readable storage media such as one or more of system memory 617, fixed disk 644, optical disk 642, or floppy disk 638. The operating system provided on computer system 610 may be MS-DOS®, MS-WINDOWS®, OS/2, UNIX®, Linux®, or another known operating system.

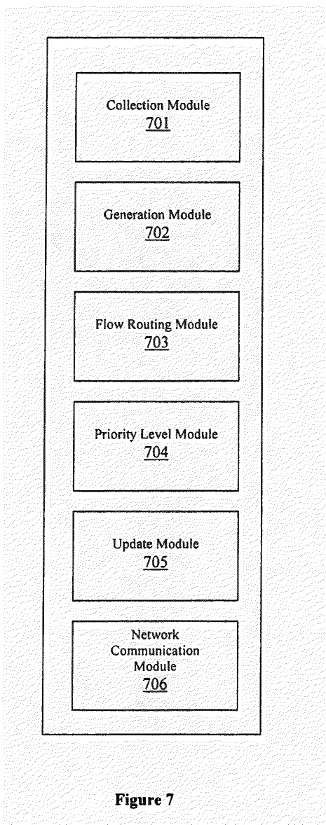

FIG. 7 illustrates a set of code (e.g., programs) and data that is stored in memory of one embodiment of a controller, such as the controller set forth in FIG. 6. The controller uses the code, in conjunction with a processor, to implement the necessary operations (e.g., logic operations) to implement the described herein.

Referring to FIG. 7, the memory 660 includes a collection module 701 which when executed by a processor is responsible for collecting signal strength measurements from wireless entities (e.g., base stations), channel quality indicators (CQI) information provided by UEs, collects packet loss information and/or information specifying retransmission events as described above.

The memory also stores a generation module 702 which, when executed by a processor, is responsible for generating a CQI estimate for each of the wireless entities (e.g., base stations) not serving a flow to a UE. These are the missing CQI estimates.

The memory also stores a flow routing module 703 which, when executed by a processor, is responsible for determining forwarding decisions for flows to specify which wireless entity is to serve which flow.

Memory 660 also stores priority level module 704, which when executed by a processor, is responsible for determining flow priority decisions for flows of the one or more flows.

Memory 660 also includes update module 705 to generate flow table update information and flow priority update information, as described above, for transmission to wireless entities, such as base stations, routers and switches.

The memory also includes a network communication module 706 used for performing network communication and communication with the other devices (e.g., base stations, routers, switches, etc.).

As described above, the controller in FIG. 1 that performs flow and priority control implemented using a computer system such as depicted in FIG. 6, except using different code to facilitate the receipt of a session from another security gateway. The code is stored in computer-readable storage medium such as system memory 617, fixed disk 644, optical disk 642 or floppy disk 648.

Advantageously, embodiments of the invention logically centralize the forwarding and quality of service (QoS) or quality of experience (QoE) decisions for each network flow to the same or distinct wireless subscribers while maintaining the distributed and scalable structure of the forwarding plane. Also, embodiments of the invention do not require a change in radio stack and transmission standards, yet it allows a more globally optimized resource allocation decisions based on the network state and flow QoS/QoE requirements. Furthermore, embodiments of the invention provide a better utilization of coverage and capacity based on the network load and flow requirements using a novel architecture and disclosing methods on how to program the forwarding plane.

Moreover, embodiments of the invention allow network operators a better way of utilizing capacity and coverage of the network over heterogeneous networks with many small cells are overlaid by macro cells.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

I claim:

1. A method for use in a wireless network apparatus comprising a controller, a plurality of wireless entities controlled by the controller, and one or more user equipments (UEs), the plurality of wireless entities including at least one base station, the method comprising:
collecting, by the controller, signal strength measurements from entities of the plurality of wireless entities;
collecting, by the controller, channel quality indicators (CQI) information provided by one or more UEs of the at least one UEs;
generating a CQI estimate for each entity of the plurality of entities not serving a flow to a UE; and
determining, by the controller, forwarding decisions for one or more flows to specify which wireless entity is to serve which flow, based on one or more of the signal strength measurements, the channel quality indicators (CQIs) provided by one or more UEs, and one or more generated CQI estimates associated with entities not serving a flow to a UE.

2. The method defined in claim 1 further comprising collecting one or both of packet loss information and information specifying retransmission events, and wherein determining forwarding decisions for the one or more flows is based on the one or both of packet loss information and information specifying retransmission events.

3. The method defined in claim 1 further comprising sending information to update flow routing table entries of one or more wireless entities of the plurality of wireless entities.

4. The method defined in claim 1 further comprising determining, by the controller, flow priority decisions for flows of the one or more flows, based on one or more of the signal strength measurements, the channel quality indicators (CQIs) provided by one or more UEs, and one or more generated CQI estimates associated with entities not serving a flow to a UE.

5. The method defined in claim 4 wherein determining flow priority decisions for flows of the one or more flows is based on updated flow quality requirements.

6. The method defined in claim 5 wherein determining forwarding decisions for one or more flows to specify which wireless entity is to serve which flow is based on updated flow quality requirements.

7. The method defined in claim 1 wherein the channel quality indicators (CQI) information provided by the one or more UEs is provided to the controller via a wireless entity currently serving a flow to the UE.

8. The method defined in claim 1 wherein determining forwarding decisions for one or more flows to specify which wireless entity is to serve which flow comprises selecting a wireless entity with a best CQI in comparison to the other wireless entities in the plurality of entities to serve a particular flow.

9. The method defined in claim 1 wherein determining forwarding decisions for one or more flows to specify which wireless entity is to serve which flow comprises switching from a first wireless entity serving a particular flow to a second wireless entity to serve the particular flow if CQI information of the first wireless entity drops to below a value.

10. The method defined in claim 9 wherein the value is a threshold value.

11. The method defined in claim 9 wherein the value is CQI information of the second wireless entity.

12. The method defined in claim 1 further comprising communicating with a QoS scheduler to change a flow priority level.

13. The method defined in claim 1 wherein the plurality of wireless entities comprises one or more network routers.

14. The method defined in claim 12 wherein the one or more routers comprises edge or gateway routers.

15. A wireless communication system comprising:
at least one user equipment (UE);
a plurality of wireless entities including at least two base stations and one or more other networking entities;
a controller, communicably coupled to the plurality of base stations and the one or more network entities, to control the plurality of base stations and the one or more network entities by collecting signal strength measurements from entities of the plurality of wireless entities, channel quality indicators (CQI) information provided by one or more UEs of the at least one UE, generating a CQI estimate for each entity of the plurality of entities not serving a flow to a UE, and determining forwarding decisions for one or more flows to specify which wireless entity is to serve which flow, based on one or more of the signal strength measurements, the channel quality indicators (CQIs) provided by one or more UEs, and one or more generated CQI estimates associated with entities not serving a flow to a UE.

16. The wireless communication system defined in claim 15 wherein the controller is operable to collect one or both of packet loss information and information specifying retransmission events and determine forwarding decisions for the one or more flows based on the one or both of packet loss information and information specifying retransmission events.

17. The wireless communication system defined in claim 15 wherein the controller sends information to update flow routing table entries of one or more wireless entities of the plurality of wireless entities.

18. The wireless communication system defined in claim 15 wherein the controller determines flow priority decisions for flows of the one or more flows, based on one or more of the signal strength measurements, the channel quality indicators (CQIs) provided by one or more UEs, and one or more generated CQI estimates associated with entities not serving a flow to a UE.

19. The wireless communication system defined in claim 18 wherein the controller determines flow priority decisions for flows of the one or more flows also based on updated flow quality requirements.

20. The wireless communication system defined in claim 19 wherein the controller determines forwarding decisions for one or more flows to specify which wireless entity is to serve which flow is based on updated flow quality requirements.

21. The wireless communication system defined in claim 15 wherein the channel quality indicators (CQI) information provided by the one or more UEs is provided to the controller via a wireless entity currently serving a flow to the UE.

22. The wireless communication system defined in claim 15 wherein the controller determines forwarding decisions for one or more flows to specify which wireless entity is to serve which flow comprises selecting a wireless entity with a best CQI in comparison to the other wireless entities in the plurality of entities to serve a particular flow.

23. The wireless communication system defined in claim 15 wherein the controller determines forwarding decisions for one or more flows to specify which wireless entity is to serve which flow comprises switching from a first wireless entity serving a particular flow to a second wireless entity to serve the particular flow if CQI information of the first wireless entity drops to below a value.

24. The wireless communication system defined in claim 15 wherein the plurality of wireless entities comprises one or more network routers.

25. An article of manufacture having one or more non-transitory storage media storing instructions which, when executed by a controller in a wireless network apparatus performs a method, the wireless network apparatus comprising a plurality of wireless entities controlled by the controller and one or more user equipments (UEs), the plurality of wireless entities including at least one base station, the method comprising:
collecting, by the controller, signal strength measurements from entities of the plurality of wireless entities;
collecting, by the controller, channel quality indicators (CQI) information provided by one or more UEs of the at least one UEs;
generating a CQI estimate for each entity of the plurality of entities not serving a flow to a UE; and
determining, by the controller, forwarding decisions for one or more flows to specify which wireless entity is to serve which flow, based on one or more of the signal strength measurements, the channel quality indicators (CQIs) provided by one or more UEs, and one or more generated CQI estimates associated with entities not serving a flow to a UE.

26. The method defined in claim 25 further comprising collecting one or both of packet loss information and information specifying retransmission events, and wherein determining forwarding decisions for the one or more flows is based on the one or both of packet loss information and information specifying retransmission events.

27. The method defined in claim 25 further comprising determining, by the controller, flow priority decisions for flows of the one or more flows, based on one or more of the signal strength measurements, the channel quality indicators (CQIs) provided by one or more UEs, and one or more generated CQI estimates associated with entities not serving a flow to a UE.
